(19) United States
(12) Patent Application Publication
(10) Pub. No.: US 2019/0073728 A1
(43) Pub. Date: Mar. 7, 2019

(54) Process and Method of Project Materials Marking and Labeling

(71) Applicants: Clay R. Gott, Memphis, TN (US); Jan Kirsten, Memphis, TN (US)

(72) Inventors: Clay R. Gott, Memphis, TN (US); Jan Kirsten, Memphis, TN (US)

(21) Appl. No.: 15/694,887

(22) Filed: Sep. 4, 2017

(51) Int. Cl. G06Q 50/08; G06Q 10/06

(52) U.S. Cl. CPC G06Q 50/08; G06F 3/0482; G06Q 10/06313

(57) ABSTRACT

The present disclosure reveals a system and method for project materials marking and labeling comprising a set of instructions that reside on a non-transitory computer-readable medium within a server, a plurality of databases with which the set of instructions interact, a plurality of inputs to access the set of instructions, and a plurality of outputs capable of marking and labeling materials. The material type, location, quantities, and dimensions of all of these materials and the associated parts and equipment begin on a plurality of plans for the project based on computer aided design drawings for the project to be built. Each material is then identified by a unique indicator that correlates the material with a specifically identified and marked location on the plurality of plans. Once identified, the materials and associated parts are quantified and the dimensions identified. The materials are then marked according to the required dimensions for each location in the project and labeled according to where each material item is to be located and installed in the project.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### FIELD OF THE INVENTION

This disclosure reveals a process and method for accepting project data, calculating material type, location, quantities, and dimensions for the project, labeling of each individual piece of material according to the location of the material in the project, and the marking the materials according to the identified dimensions of the material, all prior to delivery or pickup. In a further embodiments, the materials are cut to the identified dimensions and selection of types of materials and the associated parts and equipment for the project can occur. The project data originates from a database of pre-designed objects or is uploaded.

### BACKGROUND OF THE INVENTION

Construction projects from the building of a dog house to the construction of a sky scraper involve materials and require the ability to select the types of material, quantities for each type of material, the dimensions for each type of material, and then the ability to fabricate each type of material to the appropriate dimensions based on where each piece and type of material is to be located in the design of the project. The process of obtaining each type and piece of material and then fabricating it to fit to a specific location in a project is time consuming, can create quite a mess from the debris and scrap left over from the fabrication process, and all of the scrap and debris requires disposal. To date there is no integrated process whereby project materials can be identified and marked prior to arrival on a jobsite in order to facilitate execution of the project, or to simplify the fabrication process and minimize the waste associated with construction projects.

The present disclosure reveals a process and method whereby, based on the design of the project, all of the materials and associated parts and equipment for a project can be identified by type and location of each type of material in the project, and then each piece of material can then be marked according to a location identified in the project and the dimensions required for the specific material.

### SUMMARY OF THE INVENTION

Construction activities, from the building of a dog house to the construction of a sky scrapper require materials such as lumber, piping, conduits, ducting, I-beams, structural steel, cabling, as well as all of the associated parts and equipment required to assemble and install each piece of material. Parts include such things as but not limited to nails, connectors, couplings, wire-nuts, welding rods, hangers, plates, electrical boxes, covers, screws, bolts, and washers. Equipment includes but is not limited to fans, furnaces, air conditioners, lights, shingles, and tar paper.

The material type, location, quantities, and dimensions of all of these materials and the associated parts and equipment required to assemble and install each piece of material can now be identified electronically on a plurality of plans for the project based on computer aided design drawings for the project to be built. Each material item in the project can then be identified by a unique indicator that correlates the material with a specifically identified and marked location on the plurality of plans. Once identified, the materials and associated parts can be quantified and the dimensions identified. The materials can then be marked, with the use of dye, pigment, graphite, or chalk, according to the required dimensions for each location in the project and labeled according to where each material item is to be located and installed in the project.

In the first embodiment of the disclosure, the project is selected from a database of predetermined projects. These projects have the materials, parts and equipment pre-calculated and the pre-calculated materials, parts and equipment, along with appropriate excesses for errors and fitting are then acquired, marked according to the required dimensions for each location in the project and labeled according to where each material item is to be located and installed in the project.

The first embodiment may further comprise the ability for the materials to be fabricated according to the appropriate dimensions for each particular material.

The first embodiment may further allow for input interaction to aid in the selection of the specific characteristics of the materials and associated parts and equipment. Said characteristics may include such things as but not be limited to color, quality of material, aesthetic properties associated with appearance, pre-finishing, brand type, model, and capacity.

In the second embodiment of the disclosure, the project plan is input. The materials, parts and equipment are then identified, labels are attached to the plan according to material type and location, appropriate excesses for errors and fitting are calculated into the dimensions as necessary, and then the materials and associated parts and equipment are acquired, marked according to the required dimensions for each location in the project and labeled according to where each material item is to be located and installed in the project.

The second embodiment may further comprise the ability for the materials to be fabricated according to the appropriate dimensions for each particular material.

The second embodiment may further allow for input interaction to aid in the selection of the specific characteristics of the materials and associated parts and equipment. Said characteristics may include such things as but not be limited to color, quality of material, aesthetic properties associated with appearance, pre-finishing, brand type, model, and capacity.

### BRIEF DESCRIPTION OF THE SEVERAL VIEWS OF THE DRAWING

FIG. 1 is a schematic of the first embodiment of the system for project materials marking and labeling;

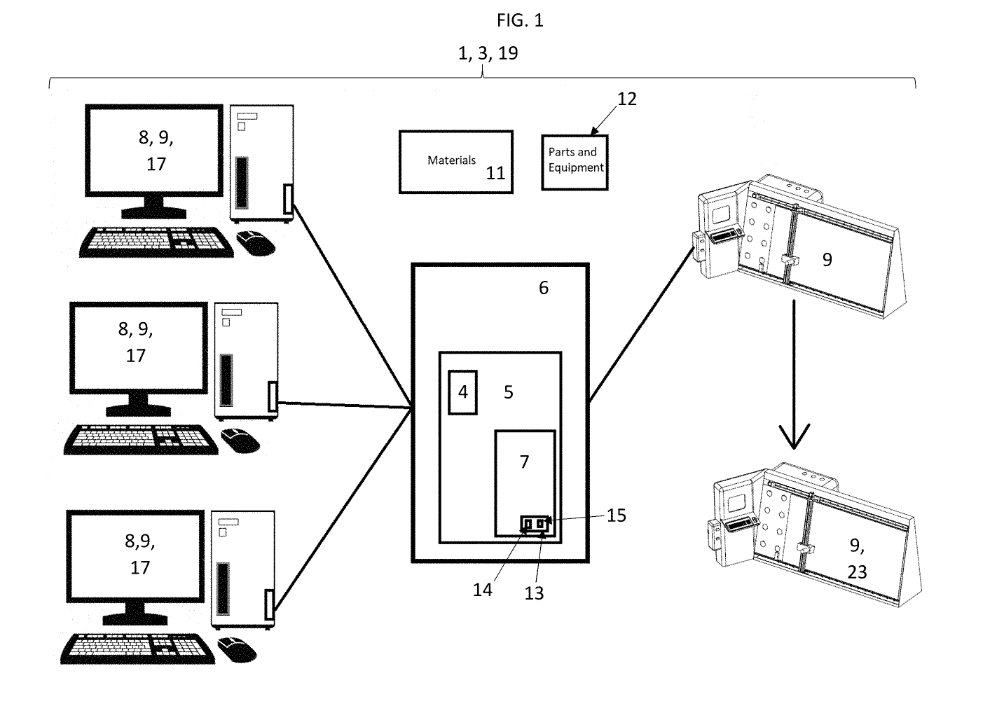

FIG. 2 is a schematic of the second embodiment of the system for project materials marking and labeling;

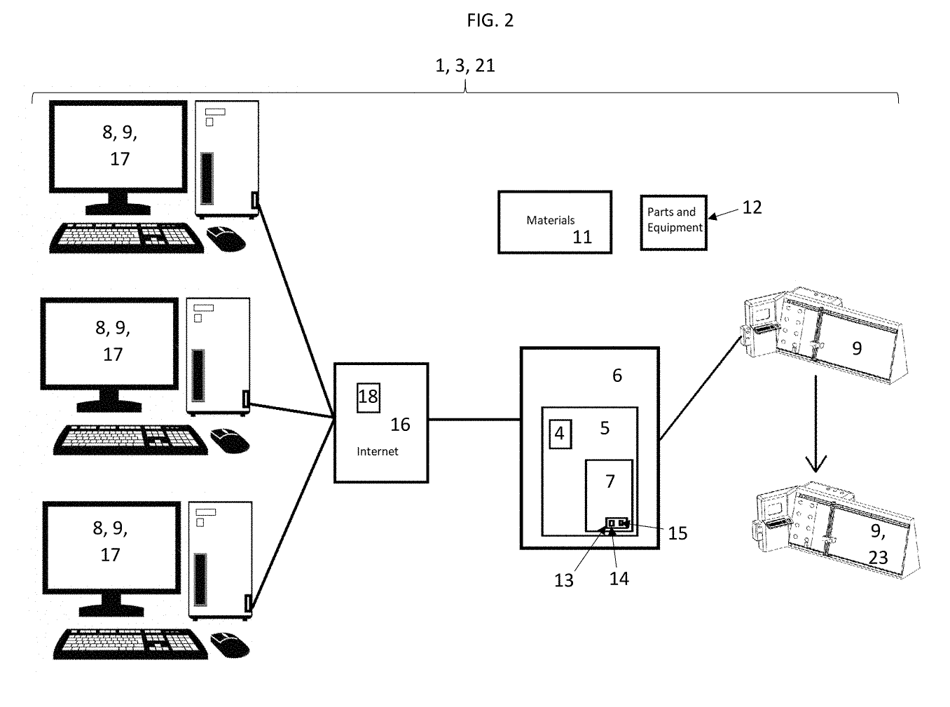

FIG. 3 is a schematic of the first embodiment of the method for project materials marking and labeling; and

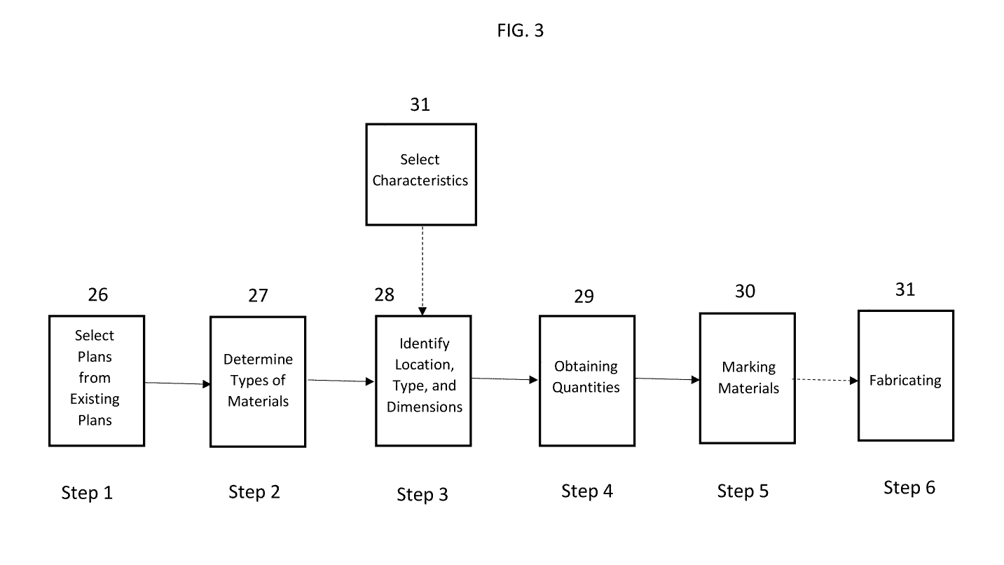

FIG. 4 is a schematic of the second embodiment of the method for project materials marking and labeling.

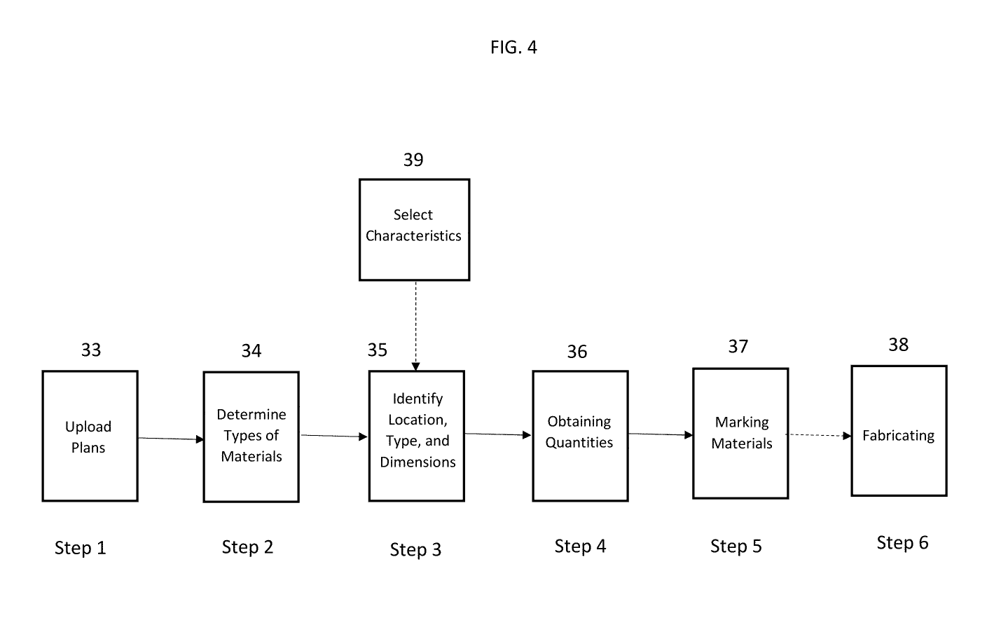

### DETAILED DESCRIPTION OF THE INVENTION

The present disclosure reveals a system 1 for project materials marking and labeling 3 comprising a set of instructions 4 that reside on a non-transitory computer-readable medium 5 within a server 6, a plurality of databases 7 with which the set of instructions 4 interact, a plurality of inputs 8 to access the set of instructions 4, and a plurality of outputs 9 capable of marking and labeling materials, said marking and labeling being completed with the use of dye, pigment, graphite, or chalk.

The set of instructions 4 are capable of receiving a plurality of plans 10 for a construction project, determining, from the select plan 10 and input 8, which of the materials 11 are to be identified from the plans 10, identifying the type, location, and dimensions of material 11 and the associated parts and equipment 12 from the plans 10, assigning each piece of material 11 and the associated parts and equipment 12 a unique identifier, compiling a database 13 for each piece of material 11 and the associated parts and equipment 12, and interacting with a plurality of databases 7 that comprise characterizations of material 11 and the associated parts and equipment 12 used in the construction industry. Said characterization comprising information such as but not limited to dimensions, weight, units of use, and pricing per unit.

The database 13 produced that compiles each piece of material 11 and the associated parts and equipment 12 is capable of being presented in either list 14 or graphic 15 format. The list 14 can be sortable by at least one of material number, material 11, part and equipment type 12, and location within the plans 10. The graphic format 15 is a plurality of plans 10 and is interactive such that the dimensions of each piece of material 11, part or equipment 12 can be identified upon demand.

The plurality of databases 7 originate from at least one of the same non-transitory computer-readable medium 5 on the server 6, the internet 16, or input 8. The set of instructions 4 being capable of analyzing the output database 13, compiling each piece of material 11 and the associated parts and equipment 12, and comparing each piece of material 11 and the associated parts and equipment 12 with the plurality of databases 7 to derive quantities necessary of each material 11 or part or equipment 12 necessary and optimize the total quantity necessary for each type of material 11 and the associated parts and equipment 12.

The plurality of inputs 8 originate from at least one of the computer 17 connected to the server 6 upon which resides the set of instructions 4 or a computer 17 connected to the internet 16, the internet 16 containing a web page 18 through which the server 6 with the set of instructions 4 can be accessed. There is a first embodiment 19 of the plans 10 wherein a plan 10 can be selected from a collection of pre-existing plans 10 contained within with the set of instructions 4. Wherein there is a second embodiment 21 of the provision of the plans 10 which is a plan 10 in computer aided design format that is uploaded from the input 8.

The system 1 for project materials marking and labeling 3 may further comprise the ability for the materials 11 to be fabricated 23 according to the appropriate dimensions for each particular material 11.

The system 1 for project materials marking and labeling 3 may also comprise the ability to allow for input interaction to aid in the selection of the specific characteristics of the materials 11 and associated parts and equipment 12. Said characteristics may include such things as but not be limited to color, quality of material, aesthetic properties associated with appearance, pre-finishing, brand type, model, and capacity.

The present disclosure reveals a method 2 for project materials marking and labeling 3 comprising a set of instructions 4 that reside on a non-transitory computer-readable medium 5 within a server 6, a plurality of databases 7 with which the set of instructions 4 interact, a plurality of inputs 8 to access the set of instructions, and a plurality of outputs capable 9 of marking and labeling materials 11 comprising first 26, selecting a plan 10 from a plurality of pre-existing plans 10 associated with the set of instructions 4; second 27, determining which type of materials 11 are to be identified from the plans 10; third 28, identifying the location, type and dimension of each piece of material 11 and the associated parts and equipment 12 necessary; fourth 29, obtaining the appropriate quantity of each type of material 11 and the associated parts and equipment 12; and fifth 30, marking each type of material 11 according to the dimensions of the related pieces of material 11 along with each piece of material's 11 unique label.

The method 2 for project materials marking and labeling 3 may further comprise a sixth step 31 the ability for the materials 11 to be fabricated 23 according to the appropriate dimensions for each particular material 11.

The method for project materials marking and labeling may further comprise an addition to the third step 28, the ability to allow for input interaction to aid in the selection of the specific characteristics of the materials 11 and associated parts and equipment 12. Said characteristics may include such things as but not be limited to color, quality of material, aesthetic properties associated with appearance, pre-finishing, brand type, model, and capacity.

The present disclosure reveals a method 2 for project materials marking and labeling 3 comprising a set of instructions 4 that reside on a non-transitory computer-readable medium 5 within a server 6, a plurality of databases 7 with which the set of instructions 4 interact, a plurality of inputs 8 to access the set of instructions 4, and a plurality of outputs 9 capable of marking and labeling materials 11 comprising first 33, uploading a plan 10 to the server 6; second 34, determining which type of materials 11 are to be identified from the plans 10; third 35, identifying the location, type and dimension of each piece of material 11 and the associated parts and equipment 12 necessary for the plan 10; fourth 36, obtaining the appropriate quantity of each type of material 11 and the associated parts and equipment 12; and fifth 37, marking each type of material 11 according to the dimensions of the related pieces of material 11 for the project along with each piece of material's 11 unique label.

The method 2 for project materials marking and labeling 3 may further comprise a sixth step 38, the ability for the materials 11 to be fabricated 23 according to the appropriate dimensions for each particular material 11.

The method 2 for project materials marking and labeling 3 may further comprise, during the third step 35, the ability to allow for input interaction to aid in the selection of the specific characteristics of the materials 11 and associated parts and equipment 12. Said characteristics may include such things as but not be limited to color, quality of material, aesthetic properties associated with appearance, pre-finishing, brand type, model, and capacity.

What is claimed:

1. A system for project materials marking and labeling comprising:
a set of instructions that reside on a non-transitory computer-readable medium within a server, a plurality of databases with which the set of instructions interact, a plurality of inputs to access the set of instructions, and a plurality of outputs capable of marking and labeling materials;
said set of instructions capable of receiving a plurality of plans, determining, though input, which of the materials are to be identified from the plans, identifying the type, location and dimensions of material and the associated parts and equipment for the project from the plans, assigning each piece of material and the associated parts and equipment a unique identifier, compiling a database for each piece of material and the associated parts and equipment, and interacting with a plurality of databases that comprising characterizations of material and the associated parts and equipment used in the construction industry;
said database compiling each piece of material and the associated parts and equipment being capable of being presented in either list or graphic format, wherein said list can be sortable by at least one of material number, material, part and equipment type, and location, and wherein said graphic format is a plurality of plans and is interactive such that the dimensions of each piece of material, part or equipment can be identified upon demand;
wherein the plurality of databases originate from at least one of the same non-transitory computer-readable medium on the server or from input, the set of instructions being capable of analyzing the plans, compiling each piece of material and the associated parts and equipment associated with the plans, comparing the derived list of materials and the associated parts and equipment with the plurality of databases to derive quantities necessary of each material, part or equipment necessary to optimize the total quantities necessary for each type of material and the associated parts and equipment; and
said plurality of inputs originating from at least one of a computer attached to the server upon which resides the set of instructions or a computer connected to the internet, which contains a web page through which the server with the set of instructions can be accessed, wherein said plurality of inputs can provide a project, and wherein the provision of the project wherein a project is selected from a collection of pre-existing projects associated with the set of instructions.

2. The system for project materials marking and labeling of claim 1 further comprising the ability for the materials to be fabricated according to the appropriate dimensions for each particular material.

3. The system for project materials marking and labeling of claim 1 further comprising the ability to allow for input interaction to aid in the selection of the specific characteristics of the materials and associated parts and equipment;
said characteristics may include such things as but not be limited to color, quality of material, aesthetic properties associated with appearance, pre-finishing, brand type, model, and capacity.

4. The system for project materials marking and labeling of claim 3 further comprising the ability for the materials to be fabricated according to the appropriate dimensions for each particular material.

5. A system for project materials marking and labeling comprising:
a set of instructions that reside on a non-transitory computer-readable medium within a server, a plurality of databases with which the set of instructions interact, a plurality of inputs to access the set of instructions, and a plurality of outputs capable of marking and labeling materials;
said set of instructions capable of receiving a plurality of plans, determining, though input, which of the materials are to be identified from the plans, identifying the type, location and dimensions of material and the associated parts and equipment from the plans, assigning each piece of material and the associated parts and equipment a unique identifier, compiling an output database for each piece of material and the associated parts and equipment, and interacting with a plurality of databases that comprise characterizations of material and the associated parts and equipment used in the construction industry;
said output database compiling each piece of material and the associated parts and equipment being capable of being presented in either list or graphic format, wherein said list can be sortable by at least one of material number, material, part and equipment type, and location, and wherein said graphic format is a plurality of plans representing the project and is interactive such that the dimensions of each piece of material, part or equipment can be identified upon demand;
wherein the plurality of databases originate from at least one of the same non-transitory computer-readable medium on the server, from input, or from the internet; the set of instructions being capable of analyzing the plans, compiling each piece of material and the associated parts and equipment into an output database, comparing the output database with the plurality of databases to derive quantities necessary of each material, part or equipment necessary to construct the project and optimize the total quantity necessary for each type of material and the associated parts and equipment for the project; and
said plurality of inputs originating from at least one of a computer connected to the server upon which resides the set of instructions or a computer connected to the internet, the internet containing a web page through which the server with the set of instructions can be accessed, wherein said plurality of inputs can provide a plan, and wherein the provision of the plans are plans in computer aided design format that is uploaded.

6. The system for project materials marking and labeling of claim 5 further comprising the ability for the materials to be fabricated according to the appropriate dimensions for each particular material.

7. The system for project materials marking and labeling of claim 5 further comprising the ability to allow for input interaction to aid in the selection of the specific characteristics of the materials and associated parts and equipment;
said characteristics may include such things as but not be limited to color, quality of material, aesthetic properties associated with appearance, pre-finishing, brand type, model, and capacity.

8. The system for project materials marking and labeling of claim 7 further comprising the ability for the materials to be fabricated according to the appropriate dimensions for each particular material.

9. A method for project materials marking and labeling comprising:
a set of instructions that reside on a non-transitory computer-readable medium within a server, a plurality of databases with which the set of instructions interact, a plurality of inputs to access the set of instructions, and a plurality of outputs capable of marking and labeling materials wherein;
first, selecting plans from a collection of pre-existing plans associated with the set of instructions;
second, determining which type of materials are to be identified from the plans;
third, identifying the location, type, and dimension of each piece of material and the associated parts and equipment necessary from the plans;
fourth, obtaining the appropriate quantity of each type of material and the associated parts and equipment; and
fifth, marking each type of material according to the dimensions of the related pieces of material for the project along with each piece of material's unique label.

10. The method for project materials marking and labeling of claim 9 further comprising a sixth step, an ability for the materials to be fabricated according to the appropriate dimensions for each particular material.

11. The method for project materials marking and labeling further comprising, during the third step, an ability to allow for input interaction to aid in the selection of the specific characteristics of the materials and associated parts and equipment, said characteristics may include such things as but not be limited to color, quality of material, aesthetic properties associated with appearance, pre-finishing, brand type, model, and capacity.

12. The method for project materials marking and labeling of claim 11 further comprising a sixth step, an ability for the materials to be fabricated according to the appropriate dimensions for each particular material.

13. A method for project materials marking and labeling comprising:
a set of instructions that reside on a non-transitory computer-readable medium within a server, a plurality of databases with which the set of instructions interact, a plurality of inputs to access the set of instructions, and a plurality of outputs capable of marking and labeling materials wherein:
first, uploading plans to the server;
second, determining which type of materials are to be identified from the plans;
third, identifying the location, type and dimension of each piece of material and the associated parts and equipment necessary from the plans;
fourth, obtaining the appropriate quantity of each type of material and the associated parts and equipment; and
fifth, marking each type of material according to the dimensions of the related pieces of material for the project along with each piece of material's unique label.

14. The method for project materials marking and labeling of claim 13 further comprising a sixth step of an ability for the materials to be fabricated according to the appropriate dimensions for each particular material.

15. The method for project materials marking and labeling of claim 13 further comprising, during the third step, an ability to allow for input interaction to aid in the selection of the specific characteristics of the materials and associated parts and equipment, said characteristics may include such things as but not be limited to color, quality of material, aesthetic properties associated with appearance, pre-finishing, brand type, model, and capacity.

16. The method for project materials marking and labeling of claim 15 further comprising a sixth step, an ability for the materials to be fabricated according to the appropriate dimensions for each particular material.
